(19) United States
(12) Patent Application Publication
(10) Pub. No.: US 2018/0274389 A1
(43) Pub. Date: Sep. 27, 2018

(54) TURBOMACHINE HAVING A MOUNTING ELEMENT

(71) Applicant: MTU Aero Engines AG, Muenchen (DE)

(72) Inventor: Thomas MILLER, Emmering (DE)

(21) Appl. No.: 15/928,205

(22) Filed: Mar. 22, 2018

(30) Foreign Application Priority Data
Mar. 23, 2017 (DE) 102017204954.5

(51) Int. Cl. F01D 25/28; F01D 25/16; F01D 25/18

(52) U.S. Cl. CPC F01D 25/28; F01D 25/162; F01D 25/18; F05D 2220/323; F05D 2300/505; F05D 2240/90; F05D 2250/90; F05D 2260/30; F05D 2300/50212; F05D 2230/31

(57) ABSTRACT

A to turbomachine (1) is provided, having a first component (21) and a second component (5) which are assembled together in an arrangement relative to each other in the turbomachine (1), and further having a mounting element (22) which at least stabilizes the first component (21) and a second component (5) in their relative arrangement. The mounting element (22) is either in the form of a bimetallic element or contains a shape memory alloy.

This claims the benefit of German Patent Application DE 102017204954.5, filed Mar. 23, 2017 and hereby incorporated by reference herein.

The present invention relates to a turbomachine having a mounting element.

### BACKGROUND

As will be described in detail below, the turbomachine may preferably be a jet engine. In addition to the components disposed in the hot gas duct, such as stator vanes and rotor blades, such a turbomachine has a multitude of other components which are assembled together in a specific arrangement relative to one another. Such components may be load-bearing components which serve as bearings, holders, etc., for other components. Moreover, there are fluid lines, not only for fuel supply, but also, for example, for supplying a lubricant to a bearing, or for venting purposes. In any case, the challenge is to assemble different components together and stabilize them in their relative arrangement. To this end, a mounting element may be provided to brace one component against the other.

### SUMMARY OF THE INVENTION

The present invention addresses the technical problem of providing a particularly advantageous turbomachine having a mounting element.

The provides a turbomachine, where the mounting element takes the form of a bimetallic element, and, a turbomachine, where the mounting element contains a shape memory alloy.

Preferred embodiments will be apparent from the present description. In the description of the features, a distinction is not always drawn specifically between apparatus, device and method aspects. In any case, the disclosure applies both to inventive apparatus, devices and methods.

Both approaches, namely the bimetallic element and the shape memory alloy are based on the same inventive idea, namely that both mounting elements undergo a change in their shape in response to a change in temperature, the bimetal reversibly, the shape memory alloy sometimes only once a snapping into place (one-way memory effect, as described below below for more details). The deformation behavior may be advantageous, for example, in that during assembly or installation, the mounting element has a first shape which may be optimized, for example, for installation; i.e., to facilitate insertion, especially in the case of difficult-to-access locations. The mounting element typically has this first shape at room temperature, and it may then be caused, for example by heating, to assume a second shape that is optimized for the stabilization function; i.e., for the desired relative arrangement and support of the components.

The bimetallic element may assume this second shape, for example, at the high temperatures to which the components of the turbomachine are exposed during operation thereof. Using the shape memory alloy, it is possible, on the one hand, to achieve such a reversible behavior (two-way memory effect, see below). On the other hand, in the case of the one-way memory effect, deformation may also occur only once. This single deformation may occur, for example, during initial operation of the turbomachine, or may previously be caused selectively, for example, by local application of hot air.

The deformation, regardless of whether single or reversible, on the one hand, allows the components that are stabilized by the mounting element relative to each other to be adjusted in their orientation relative to each other, in particular to be centered. On the other hand, the deformation may also result in improved damping characteristics, for example, when, at one component, the mounting element merely bears thereagainst and the deformation ensures frictional contact (see below for more details). Advantageously, it is possible to realize a damper which is self-adjusting or snaps into a damping-optimized position.

Preferably, the mounting element has a planar shape, and thus has a smaller dimension in a thickness direction, i.e. a smaller thickness, than in at least one, preferably all, of the planar directions perpendicular thereto. The thickness may be, for example, no greater than ⅕, 1/10 or 1/20 of the extent in the planar direction. Regardless thereof, possible lower limits may be at least 1·10⁻⁵, 10⁻⁴ or 10⁻³. Generally, the mounting element may also be plate-shaped, for example; preferably, it is strip-shaped; i.e., configured as a long narrow band-like piece (longer in a longitudinal direction than in a transverse direction normal thereto).

In the following, first the bimetallic element will be described further in detail. The bimetallic element is composed of at least two layers of materials which differ in their thermal expansion coefficients. The layers succeed one another in the thickness direction; the change in temperature then causes bending of the strip-shaped or plate-shaped bimetallic element. Preferably, the layers are composed of different metals, for example, one of nickel and the other of steel. Also possible is a combination of steel and a brass alloy, for example. It is expressly noted that the term “metal” should be read to include not only pure metals, but also alloys, for example. Regardless thereof, and more specifically, the layers of the bimetallic element are joined by a material-to-material bond and/or in a form-locking manner. It is also possible, for example, to apply one layer to the other as a coating. On the other hand, the layers may also be produced separately beforehand and may then be joined and/or clamped, for example only at their opposite ends with respect to their longitudinal extent. In any case, the layers can then not move completely freely relative to each other. This, in conjunction with the different thermal expansion coefficients, is the reason why a change in temperature causes bending.

In a preferred embodiment, the bimetallic element increasingly stabilizes the first and second components in their relative arrangement when the temperature increases; i.e., it holds the components in their relative arrangement with increasing force as the temperature increases. Generally, however, an opposite behavior would also be conceivable as an “optimization of the stabilization function,” such as when components are to be held relative to each other with more play at the higher temperature. However, in the preferred case where the stabilization increases with temperature, the deformation causes the contact pressure of the mounting element transverse to its longitudinal or planar extent to increase toward higher temperatures.

In so far as reference is made to an “increase in temperature” or, in general words, to a “change in temperature” generally in the context of this disclosure, a corresponding behavior may in any case occur within a temperature interval which may span, for example, at least 50° C., 100° C., 150° C., 200° C., 250° C. or 300° C. (possible upper limits may be, for example, 1500° C. or 1000° C. and may be due to a disintegration of the materials at elevated temperatures). Generally, the behavior is also to be seen against the background of the temperatures occurring in the turbomachine. The components discussed herein and the mounting element are preferably located outside the hot gas duct, and may, in particular, also be casing parts or transition pieces into the casing.

During operation of the turbomachine, the components may preferably reach an operating temperature of at least 100° C., further and particularly preferably of at a least 150° C. or 200° C. Regardless thereof, possible upper limits may be 800° C., 600° C., 500° C., 400° C. or 300° C. at maximum. The “increase in temperature” may then, for example, span at least a temperature interval from room temperature (20° C.) to the operating temperature (and therebeyond, which, however, is irrelevant for the functionality).

In a preferred embodiment, at least one of the layers of the bimetallic element has a varying thickness over its planar extent. In the case of the strip-shaped mounting element, the thickness may vary, for example, along the longitudinal direction of the strip. For example, the thickness may first increase and then decrease from one end to the other, possibly in connection with a central region of constant thickness. Also, the variation in thickness does not necessarily have to be continuous; step changes are also possible. Preferably, both or all layers of the bimetallic element may have such a varying thickness. The varying thickness may be of interest, for example, when it comes to obtaining a non-linear or transient, time-dependent behavior. Due to the different thicknesses, the different regions do not immediately assume the same temperature; a thicker region may be more “sluggish.”

Moreover, the thickness also affects the mechanical properties. For example, a thicker region is deformed by a force introduced by the other layer to a lesser extent than a thinner region. Such a non-linear or transient behavior can be used to selectively adjust the contact pressure of the mounting element, which may be of interest, in particular with regard to the damping function. Thus, for example, it is possible to selectively damp oscillations or vibrations which may occur, for example, during spool-up of the turbomachine. In general words, a mounting element having a transient behavior can be selectively optimized for temperature changes.

As mentioned earlier, the present invention also relates to a turbomachine having a mounting element which contains a shape memory alloy. The shape memory alloy can assume different crystal structures, depending on the temperature; the deformation then results from a temperature-dependent lattice transformation. The high-temperature phase of the shape memory alloy is usually referred to as austenite, the low-temperature phase as martensite. With the one-way memory effect mentioned earlier, the single deformation may occur, for example, when the mounting element is pseudo-plastically deformed in the martensitic state and then heated. Subsequent cooling does not result in deformation and, therefore, such a mounting element has been referred to as “snapping into place” hereinabove. In the case of the shape memory alloy, this is preferred, although, in general, a “reversible” use similar to the bimetallic element is also possible using the two-way memory effect.

A possible shape memory alloy material may be, for example, nickel-titanium (NiTi, Nitinol) or nickel-titanium-copper (NiTiCu). However, alloys containing zinc (copper-zinc) or aluminum (CuZnAl or CuAlNi) are also possible.

The specifications in the following paragraphs concern both the bimetallic element and the shape memory alloy, unless expressly stated otherwise.

In a preferred embodiment, the mounting element is at least partially, preferably completely, manufactured through additive manufacturing. The mounting element may be composed of one material or of stacked layers of different materials. The material or materials may exhibit a variation in thickness and/or a variation in density, in particular due to voids, to make it possible to selectively obtain a transient or static deformation behavior. This allows for a wide range of geometries, which may be of particular interest, for example, with regard to the bimetallic element having the layer(s) of varying thickness.

The additive manufacturing process may be deposition welding, also referred to as direct metal deposition (DMD). The material used in this process may be provided in the form of wire or in the form of particles mixed with a gas. On the other hand, additive manufacture may also be accomplished by building up layer by layer from a powder bed by irradiating selective areas with a radiation source. Regardless of whether DMD or a powder-bed-based process is used, the radiation source is preferably a laser, and irradiation is with electromagnetic radiation, in particular laser radiation (in general, an electron beam source and an electron beam would also be possible).

In a preferred embodiment, the mounting element is fixedly connected to the first component in the turbomachine. Thus, at the point where the mounting element and the first component are placed against each other, they are not movable relative to each other.

In a preferred embodiment, the fixed connection is a material-to-material bond. In general, for example, a mounting element directly deposited on the first component is also conceivable; preferably, the mounting element and the first component are joined together, particularly preferably brazed together. Although in general, it is also possible to combine a form-locking connection with a material-to-material bond, it is preferred to use a joint that is provided solely by a material-to-material bond (without this joint, the mounting element and the first component would not be held together).

In a preferred embodiment, the first component is a fluid line. Reference is expressly made also to the options mentioned in the appraisal of the prior art. The fluid may be a liquid, but also a gas.

In a preferred embodiment, the fluid line may be a supply or discharge line for a bearing of the turbine shaft, especially of the high-pressure turbine shaft. As a supply line, the fluid line may, for example, supply lubricant thereto, and as a discharge line, it may serve for venting purposes.

In a preferred embodiment, the mounting element merely bears against the second component. Thus, the two may slide at least somewhat relative to each other in the area of contact; they are in frictional contact with each other and, therefore, the above-mentioned damping may be obtained. The expression “merely bearing against” means that they are not fixedly connected to one another, but rather engage against one another.

In a preferred embodiment, the mounting element is provided such that the contact pressure increases with increasing temperature (see also the foregoing remarks on relevant temperature ranges). The contact pressure presses the mounting element into engagement against the second component, making it possible to ensure frictional contact and, thus, to ensure damping.

In a preferred embodiment, the second component, which the mounting element merely bears against, is a strut; i.e., a load-bearing component of the turbomachine. Preferably, the strut supports the bearing of the turbine shaft, in particular high-pressure turbine shaft. The bearing is preferably disposed in the turbine section in what is known as turbine center frame. Generally, the strut supports the bearing together with further struts, which are arranged in succession circumferentially about the longitudinal axis of the turbomachine, for example, rotationally symmetrically about the longitudinal axis of the turbomachine. The struts may each extend radially outwardly from the bearing (as it were, like spokes), thereby holding the bearing centered within the casing.

The struts are fixedly connected, for example by welding and/or screwing, to the bearing, specifically to the bearing carrier. During operation, the rotor blade rings rotate about the aforementioned “longitudinal axis” of the turbomachine. The radial directions are perpendicular thereto.

In a preferred embodiment, the strut is in the form of a hollow body. Thus, the strut at least partially, preferably completely, encloses an inner space, as viewed in a plane of section perpendicular to the radial direction in which the strut has its longitudinal extent. The first component, preferably the fluid line, is disposed in this inner space (or inner volume, when considering the hollow body).

Thus, the mounting element is particularly preferably attached, in particular brazed, to an outside wall of the fluid line, and the fluid line and the mounting element are together inserted as an assembly into the hollow strut body. The mounting element then merely bears against the hollow strut body, more specifically, against an inner wall surface bounding the inner volume of the hollow body. The bimetal or shape memory design of the mounting element may facilitate insertion into the hollow body during assembly, whereas during operation, a good frictional contact and the desired damping are ensured by the snapping into place or reversible engagement.

Preferably, a plurality of mounting elements may be attached to the fluid line along the longitudinal extent thereof immediately neighboring mounting elements may be spaced apart along the longitudinal axis of the fluid line by a distance of at least 20 mm or 50 mm, and (regardless thereof), for example, no more than 100 mm or 50 mm. A plurality of mounting elements may also be provided in succession circumferentially about the longitudinal axis of the fluid line, as viewed in a plane of section perpendicular to the longitudinal axis of the fluid line; preferably two mounting elements which are two-fold rotationally symmetric (about the longitudinal axis of the fluid line). Generally, in the context of the present disclosure, “a” and “an” are to be read as indefinite articles and always also as “at least one,” unless expressly stated otherwise.

The present invention also relates to a method for manufacturing a turbomachine as disclosed herein, in which the first and second components as well as the mounting element are assembled together. For further details of the method, reference is also explicitly made to the remainder of the disclosure. In the case of the shape memory alloy, the mounting element may be heated, for example also during manufacture, by at least 50° C. (and, for example, by no more than 200° C. or 150° C.) to make it snap into place (one-way memory effect). Assembly is preferably performed at room temperature, but selective cooling of the components is also conceivable. Prior to assembly, it may be preferred to additively manufacture the mounting element (as discussed above).

The present invention also relates to the use of a mounting element in the form of a bimetallic element and/or containing a shape memory alloy in a turbomachine, in particular a jet engine. In this regard, too, reference is made to the above disclosure. The shape memory and bimetal functions may also be combined in one mounting element; i.e., generally, one thing does not exclude the other. Nevertheless, it is preferred to implement only one of the functions, also for reasons of complexity.

### BRIEF DESCRIPTION OF THE DRAWING

The present invention will now be explained in more detail with reference to an exemplary embodiment. The individual features may also be essential to the invention in other combinations within the scope of the dependent claim, and, as above, no distinction is specifically made between different claim categories.

In the drawing:

FIG. 1 is a schematic view of a jet engine;

FIG. 2 is a cross-sectional view showing a supporting structure of the jet engine of FIG. 1, which includes mounting elements according to the present invention.

FIG. 3 shows schematically the mounting elements in FIG. 2 outside of strut 5; and

FIG. 4 shows schematically the bimetallic element.

### DETAILED DESCRIPTION

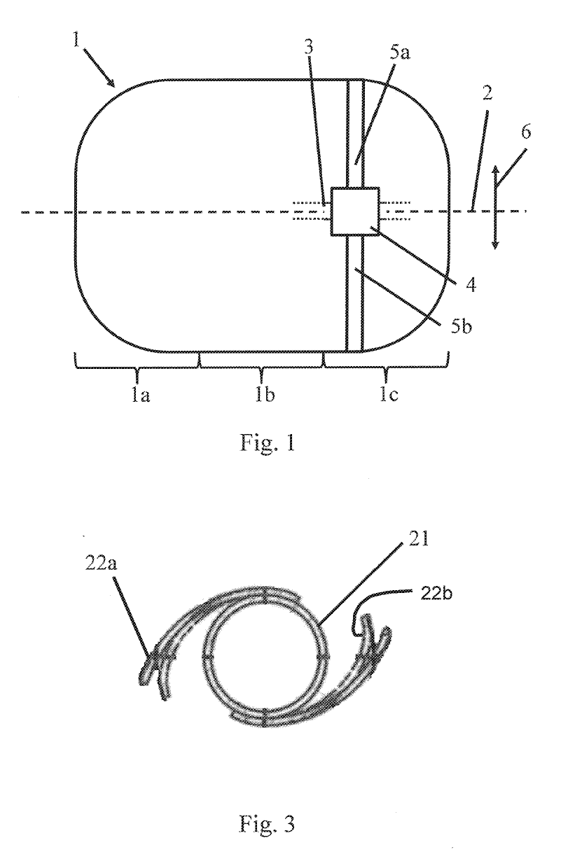

FIG. 1 shows, in schematic view, a turbomachine 1 (a jet engine). Turbomachine 1 is functionally divided into a compressor 1a, a combustor 1b and a turbine 1c. Both compressor 1a and turbine 1c are each made up of a plurality of stages (not specifically shown), each stage including a stator vane ring and a rotor blade ring. During operation, the rotor blade rings rotate about longitudinal axis 2 of turbomachine 1. Turbine shaft 3 is supported in a bearing 4 which is held by struts in the remaining portion of turbomachine 1. These struts constitute “second components” 5a, b (see below).

In the schematic part-sectional view of FIG. 1, longitudinal axis 2 of turbomachine 1 lies in the cross-sectional plane.

FIG. 2 shows a strut in a cross-sectional detail view taken in a plane perpendicular to radial direction 6 of turbomachine 1 (i.e., the plane of section of FIG. 2 is horizontal and perpendicular to the plane of the drawing of FIG. 1).

Second component 5; i.e. the strut, is a hollow body bounding an inner volume 20 in which is disposed a first component 21, namely a fluid line which may serve to supply lubricant to bearing 4 or for venting purposes. A plurality of struts are provided circumferentially about longitudinal axis 2 of turbomachine 1. Each strut may be provided with a fluid line or assigned a different function.

The fluid line, as a first component 21, and the strut, as a second component 5, are assembled together and then stabilized in their relative arrangement by means of mounting elements 22. Mounting elements 22 are each brazed to first component 21 (the fluid line), and more specifically to the outer wall surface thereof. At second component 5 (the strut), mounting elements 22 each bear flat thereagainst, and more specifically against an inner wall surface bounding inner volume 20.

In accordance with the present invention, mounting elements 22 may each be provided as a bimetallic element or made of a shape memory alloy. Accordingly, in the event of a change in temperature, a mounting element 22 may change its shape at least once (shape memory alloy, one-way memory effect) or reversibly (in the case of the bimetallic element).

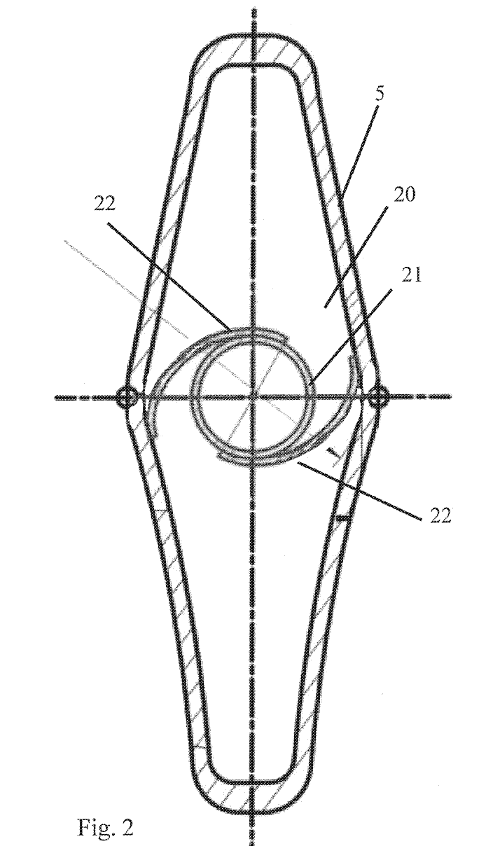

FIG. 3 illustrates this deformation, showing mounting elements 22 at two temperatures each. In the cold state, such as during assembly, mounting elements 22 have a first shape (illustrated as mounting elements 22b) and are each curved inwardly toward the fluid line. This facilitates insertion into the strut.

If no second component 5 were present, mounting elements 22 would assume the second shape shown (illustrated as mounting elements 22a as shown in FIG. 3) in response to an increase in temperature and thus bend outwardly away from the fluid line. In reality, second component 5; i.e., the strut, limits this outward deformation, as shown in FIG. 2. Therefore, mounting elements 22 are pressed into engagement against the strut 5 with increasing contact pressure as the temperature increases. Thus, this temperature-dependent behavior ensures frictional contact, so that the fluid line is supported in a vibration-damped manner in the strut.

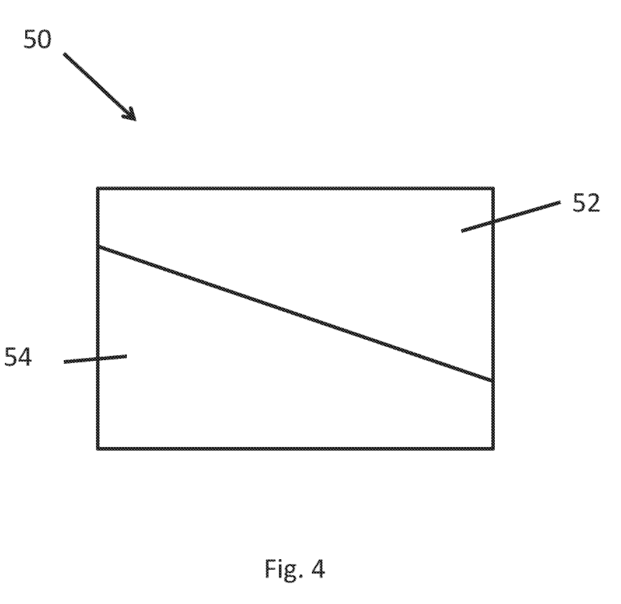

FIG. 4 shows the bimetallic element 50 including at least two contiguous layers 52, 54 made of different materials, at least one of the layers having a varying thickness over its planar extent.

What is claimed is:

1. A turbomachine comprising:
a first component and a second component assembled together in an arrangement relative to each other in the turbomachine;
a mounting element at least stabilizing the first component and a second component in the relative arrangement;
the mounting element being a bimetallic element.

2. The turbomachine as recited in claim 1 wherein the bimetallic element is provided such that the bimetallic element increasingly stabilizes the first and second components in the relative arrangement as the temperature increases.

3. The turbomachine as recited in claim 1 wherein the bimetallic element includes at least two contiguous layers made of different materials, at least one of the layers having a varying thickness over its planar extent.

4. A turbomachine comprising:
a first component and a second component assembled together in an arrangement relative to each other in the turbomachine;
a mounting element at least stabilizing the first component and a second component in the relative arrangement,
the mounting element containing a shape memory alloy.

5. The turbomachine as recited in claim 4 wherein the mounting element is at least partially manufactured through additive manufacturing.

6. The turbomachine as recited in claim 4 wherein the mounting element and the first component are fixedly connected to one another.

7. The turbomachine as recited in claim 6 wherein the mounting element and the first component are connected to one another by a material-to-material bond.

8. The turbomachine as recited in claim 6 wherein the first component is a fluid line.

9. The turbomachine as recited in claim 8 wherein the fluid line is a supply or discharge line of a bearing of a turbine shaft of the turbomachine.

10. The turbomachine as recited in claim 4 wherein the mounting element and the first component merely bear against one another.

11. The turbomachine as recited in claim 10 wherein the mounting element is provided such that a contact pressure with which the mounting element is pressed into engagement against the second component increases with increasing temperature.

12. The turbomachine as recited in claim 10 wherein the second component is a strut.

13. The turbomachine as recited in claim 12 wherein the strut supports a bearing of a turbine shaft of the turbomachine.

14. The turbomachine as recited in claim 12 wherein the strut is a hollow body in which is disposed the first component.

15. The turbomachine as recited in claim 14 wherein the strut is a fluid line.

16. A method for manufacturing a turbomachine as recited in claim 4 comprising assembling the first component and the second component as well as the mounting element together.

17. A method for mounting comprising placing a mounting element in the form of a bimetallic element or containing a shape memory alloy in a turbomachine.

18. The method as recited in claim 17 wherein the turbomachine is a jet engine.
